(19) United States
(12) Patent Application Publication
(10) Pub. No.: US 2008/0266583 A1
(43) Pub. Date: Oct. 30, 2008

(54) Three Dimensional Promotional Literature

(76) Inventor: Richard Schmaelzle, Menomonee Falls, WI (US)

Correspondence Address: ABSOLUTE TECHNOLOGY LAW GROUP LLC, 135 W. WELLS ST., SUITE 518, MILWAUKEE, WI, 53203, US

(21) Appl. No.: 12/106,978

(22) Filed: Apr. 21, 2008

Related U.S. Application Data
(60) Provisional application No. 60/915,109, filed on Apr. 30, 2007.

(51) Int. Cl. G06K 1/00; B65H 45/12; G09B 29/04

(52) U.S. Cl. 358/1.6

(57) ABSTRACT

A method, system and product for creating a customized three-dimensional promotional literature component by creating an outer promotional literature component and variable printed surface layouts and variable data elements tracked in a searchable database, creating at least one foldable insert and affixing the customized outer promotional component to the customized foldable insert.

### CROSS-REFERENCE TO RELATED APPLICATIONS

This application claims priority to U.S. Provisional Application No. 60/915,109 filed Apr. 30, 2007.

### FIELD OF INVENTION

This invention relates to the field of customized promotional literature, and more specifically to creating and tracking customized, assembled three-dimensional promotional literature with variable printed surfaces (VPS).

### BRIEF DESCRIPTION OF THE DRAWINGS

FIG. 1 is a flow chart explaining one embodiment of a method for creating customized, assembled three-dimensional promotional literature.

FIG. 2 is a flow chart explaining one embodiment of a method for creating customized, assembled three-dimensional promotional literature including communication and project management components.

FIG. 3a shows a top perspective view of one embodiment of a foldable insert for assembled three-dimensional promotional literature in the closed position.

FIG. 3b shows a top perspective view of one embodiment of a foldable insert for assembled three-dimensional promotional literature in an open position.

FIG. 3c shows a top perspective view of one embodiment of a foldable insert for assembled three-dimensional promotional literature in a partially open position attached to an outer promotional literature component.

FIG. 4 shows one embodiment of an outer promotional literature component (Front view 4a and back view 4b) for customized, assembled three-dimensional promotional literature having four Variable Printed Surfaces.

FIG. 5 shows a system diagram for one embodiment for creating customized, assembled, three-dimensional promotional literature according to the instant invention.

### BACKGROUND

With respect to the promotional and educational literature, it is desirable to use formats and layouts which have the highest level of visual impact and which may facilitate branding and product differentiation. The desire for visual impact has led to the success of processes such as Lenticular printing which creates a holographic or three-dimensional effect on printed surfaces.

Actual three-dimensional pieces requiring separate assembly can be costly to produce because they require specialized printing techniques and design layouts and substantial labor to complete the folding process, as well as coordination of all phases of printing and assembly.

Generally, three-dimensional promotional literature requires an outer promotional literature component and an inner foldable insert component which “pops out” or folds out to provide a three-dimensional effect. The foldable inserts are folded and affixed completely or partially by human labor. The outer promotional literature component requires a layout and design separate from that of the foldable insert. If information presented in these pieces changes, a new layout and project design is required and the correct outer promotional literature component must be coordinated with the corresponding foldable insert.

Customization of promotional literature and educational pieces is important to consumers for a variety of reasons. For example, products or services may be offered seasonally, may be offered by different persons within a company or group, or may be varied based on a program of targeting specific products to specific customers. Promotional literature may be targeted to a certain event, such as a tradeshow or exhibition, and it is desirable to include changeable information such as exhibitors, attendees and locations of booths, amenities, attractions and other resources. Additionally, the promotional literature may serve multiple purposes, such as a souvenir or greeting, a map, a novelty item, a demonstration or instructional piece or other purpose. While inserts which are not permanently affixed to an item of promotional literature offer flexibility because they can be inserted and removed to customize information distributed with promotional literature, these detached inserts don't have the impact of an affixed, three-dimensional foldable insert which is more difficult to detach from the outer promotional literature component.

It is desirable to have a method and system for economically customizing promotional and informational literature to reflect information to particular employees, products, services, initiatives and informational topics, and to create a system for tracking variable templates, design and data elements using a computer medium in order to potentially spread design and production costs associated with a single project over several projects.

It is further desirable to incorporate advances in printing, communications and shipping technology to create a method and system for producing three-dimensional fixed-insert literature at a manufacturing cost which allows businesses, organizations and institutions to produce customized, high-impact promotional pieces.

### Glossary

With respect to the present invention, the following terms are used to, describe exemplary embodiments of the invention:

As used herein, the term “promotional literature” refers to an item which is purchased, mailed or otherwise distributed by an individual, school, group (such as a political or issue awareness group), a recreational company, a product or service oriented company or other entity which has the purpose of promoting or disseminating any product, service, informative cause, activity, position or agenda. As used herein, an item need not be offered for the purpose of advertising to be considered promotional literature. For example, a souvenir, map, complementary informational literature, greeting, tool for visually presenting or facilitating learning of factual information or other communication may be considered promotional literature.

As used herein, the term “three dimensional” means any item designed to be viewed in more than two dimensions or has the appearance of being viewed in more than two dimensions.

As used herein, the term “foldable” or “foldable insert” means any item made of a material capable of being shaped or formed by any method of folding, including machining or by hand using locally or globally sourced labor. Generally, such insert will include a plurality of folds but may or may not include perforations, and is generally affixed to an outer promotional literature component. A foldable insert may be attached by adhesive, stapling, heat, cutting or machining, or may be a separate piece of promotional literature rather than a component. Fixed foldable inserts have the advantage over loose insert pages, cards or coupons because affixation ensures that the insert is not disassociated from the message and content of the brochure, (Traditionally, affixation of inserts has made customization of information contained within brochures and promotional materials difficult, and this is addressed by the present invention.)

As used herein, the term “outer promotional literature component” means a component or part of promotional literature that is affixed to one or more foldable inserts, and which may serve the same function as a cover to a brochure or pamphlet.

As used herein, the term “variable outer promotional literature component” means a promotional literature component which has at least one (but may have two, four, six or ten) printable surfaces, panels, sections or areas which may be separately designed, tracked via a computer medium and laid out in various combinations to create a variable and customized promotional item. Creation of a variable outer promotional literature component may involve variable data printing, variable input printing or any technology which allows variation in print and design layouts during, between and subsequent to production runs.

As used herein, the term “customization” means the act of changing, revising or recombining one or more components of promotional literature to target or more closely meet a particular need.

As used herein, the term “variable data printing” means a form of printing in which elements such as text, graphics and images may be changed from one printed piece to the next without stopping or slowing down the printing process, using information from a searchable database or external file. For example, a set of personalized letters, each with the same basic layout, can be printed with a different name and address on each letter.

As used herein, the term “computer medium” means any electronic file stored in a computer, and may include hardware or software data storage, including a data file.

As used herein, the term ‘variable printed surface” or “VPS” means any surface on which data, text or graphical elements may be printed and which may be varied by a variable data printing or equivalent process. Generally, an outer promotional literature component will be folded to have multiple variable printed surfaces, and each variable printed surface may contain one or more variable data elements in one or more separate data files stored on a computer medium, and each such file may be separately modified for customization. Each variable printed surface may further contain additional variable data elements, also stored in separate data files on a computer medium, and these files may be alternatively used to vary the content of the printed piece.

As used herein, the term ‘variable data element” or “VDE” means data elements, also stored in separate data files on a computer medium, and these files may be alternatively used to vary the content of the printed piece within a single, variable printed surface.

As used herein, the term “scoring” means marking fold lines on a foldable insert or outer promotional literature component to make them visible to the human eye or by calculating their location using numerical calculation by a computer apparatus.

As used herein, the term “project layout” means the visual effect created by one or more VPS or VDE elements.

As used herein, the term “versioning” means retrieving data files containing different versions of a VPS, VDE or print layout to create customized versions of a promotional literature component.

As used herein, the term “unique naming convention” means a system of naming VPS and VDE data files, and revisions and successive versions thereof, for systematic retrieval in a searchable database (e.g., computer data base, spreadsheet or manual record.)

### DETAILED DESCRIPTION OF EMBODIMENTS OF THE INVENTION

For the purpose of promoting an understanding of the present invention, references will be made in the text hereof to embodiments of a method for creating customized three dimensional promotional literature. It is to be understood, however, that the present invention may be embodied in various forms. Therefore, specific details disclosed herein are not to be interpreted as limiting, but rather as a basis for the claims and as a representative basis for teaching one skilled in the art to employ the present invention. One of ordinary skill in the art will readily appreciate that modifications do not depart from the spirit and scope of the present invention, some of which are mentioned in the following description.

With particular reference to the figures, the reader should also know that like numerals in different figures refer to the same elements of the embodiments. Moreover, it should be noted that each embodiment of the method for creating customized, assembled three-dimensional promotional literature utilizes at least one variable printed surfaces (VPS) with at least one variable data element (VDE) included within. In addition, additional and/or equivalent steps can be included without departing from the spirit and scope of the invention.

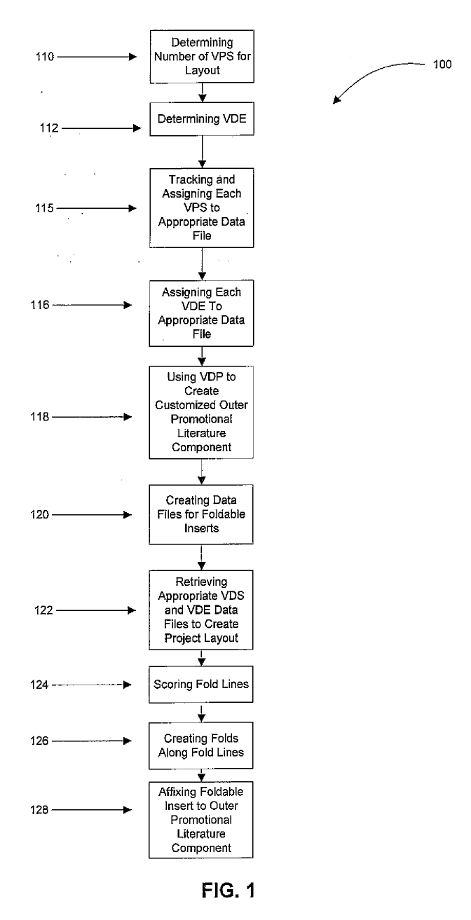

Referring now to the figures, FIG. 1 is a flow chart explaining one embodiment, Method 100, for creating a customized three-dimensional promotional literature 180. In the embodiment shown, method for creating a customized three dimensional promotional literature 100 is comprised of the step 110 determining the number of VPS's for a particular project layout and step 112 for determining the VDE's (which may include the entire layout of the VPS or which may include multiple VDE's which are combined and may be varied within the final project layout of the VPS). Method 100 further includes step 115 of tracking and assigning each VPS (115a-i) to an appropriate data file stored on a computer medium and step 116, and also assigning each VDE to an appropriate data files stored on a computer medium (116i-l). In the embodiment shown, VPS 115a-g are multiple printable surfaces which make up the outer promotional literature component (cover), VPS 115g is the binding (side) portion of the outer promotional literature component which also contains VDE printing elements and which may be of varying thicknesses and widths. VPS 15h and VPS 15i each represent the printable surface of a three dimensional pop-out foldable insert, two of which are included in the embodiment shown.

Also shown in FIG. 1 is step 118 for using a VDP or equivalent process to accept user input to identified desired VPS′ and VDE's to customize outer VPS′ 115a-i and VDE's to create a customized outer promotional literature component. Further shown is step 120 for creating data files for one or more foldable inserts, step 122 for retrieving appropriate VPS and VDE data files to create a project layout for customized three-dimensional promotional literature 180 including foldable insert 170 and outer promotional literature component 175.

Also shown in FIG. 1 is step 124 for scoring (by mechanically marking, numerically coding, printing, indenting or by other means) foldable inserts 170 to create detectible fold lines, and step 126 of creating folds along the detectible fold lines. Step 128 for affixing foldable insert 170 to outer promotional literature component 175 (by adhesive, stapling, binding, heat treatment or other means known in the art) to create and assemble customized three-dimensional promotional literature 180 is also shown. Other embodiments of Method 100 may include a means for tracking revisions made to VPS and VDE components, or the step of further including or inserting an additional item into customized three-dimensional promotional literature 180 such as a magnet, a coupon, a computer data storage device, a gift card, a prepaid card or a sample product item.

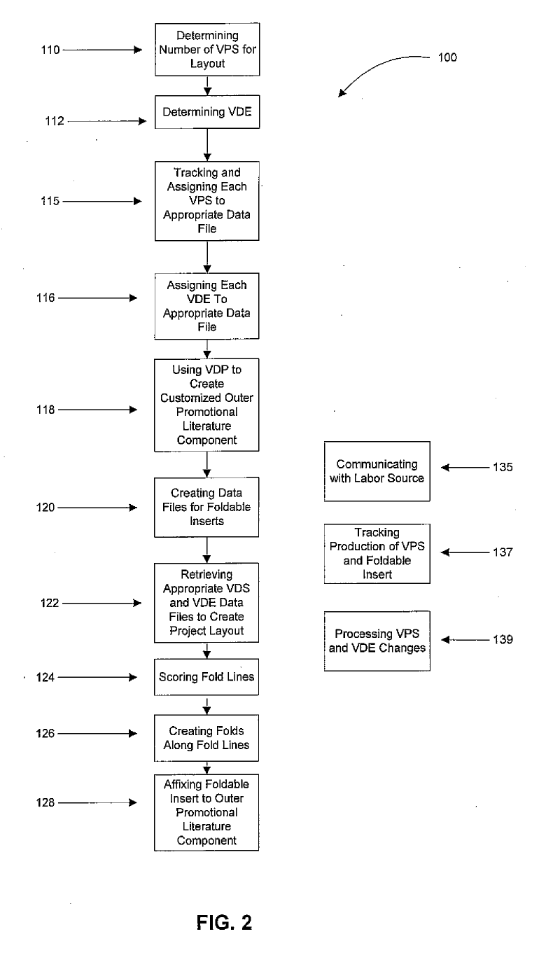

FIG. 2 shows an embodiment of Method 100 which further includes steps 135 of communicating with a labor source (such as a domestic or foreign factory or employee) using a computer or other communication interface to transmit one or more images and specifications for creating VPS, VDE and foldable insert components. Also shown is step 137 for tracking production progress of VPS and foldable insert using a communication component which may be structured according to a schedule for completion and which may further include a project management software component, and step 139 for processing VPS and VDE changes (e.g., making, tracking and documenting handling and tracking revisions, customizations and modifications to VPS and VDE elements).

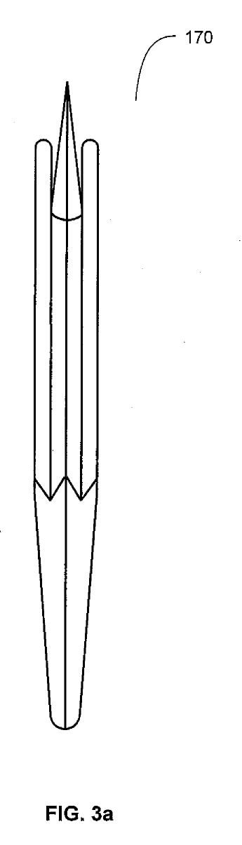

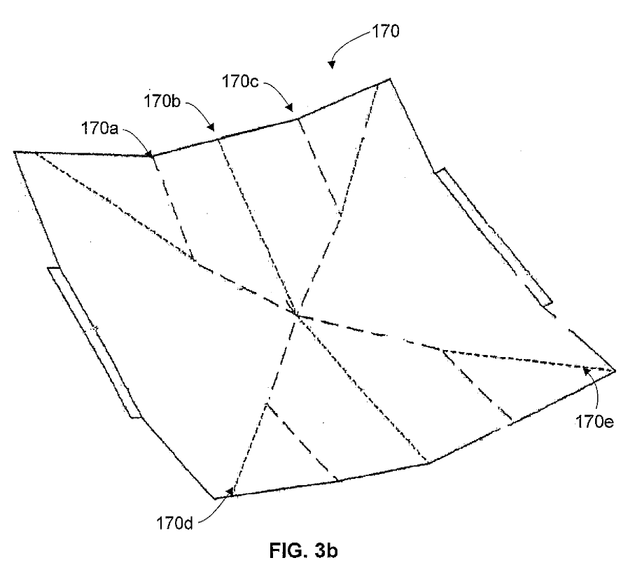

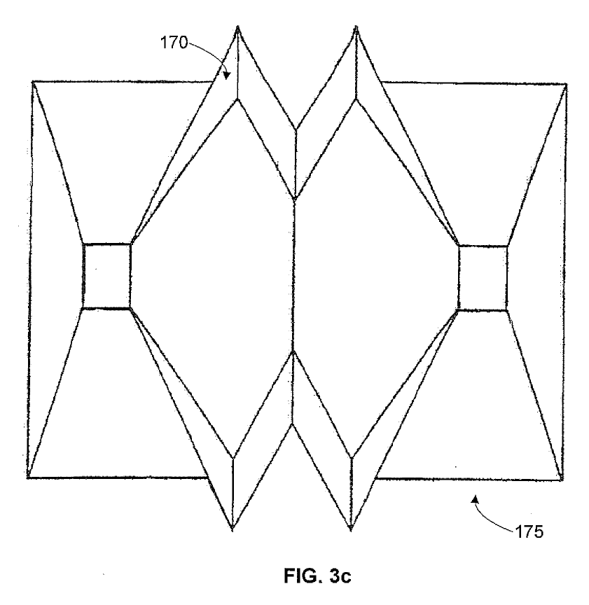

FIG. 3a shows a side view of one embodiment of foldable insert 170 in the closed position. In the embodiment shown, a process of scoring (marking) is used to identify the location desired for fold lines. Scoring may create visible lines, or lines identified by computer measurement and numerical calculation. In the embodiment shown, mechanical scoring is used to mark fold lines or expedite human labor. Folding may be accomplished by human labor, by a mechanical process or by a series of mechanical processes using one or more folding machines or apparatuses.

FIG. 3b shows a side view of one embodiment of foldable insert 170 in the open position, including lines 170a-e which have been scored (i.e., calculated and made visible or otherwise detectible by the human eye or mechanical process) and folded accordingly. In other embodiments, foldable insert 170 may have any number or configuration of score lines.

FIG. 3c shows a top perspective view of one embodiment of foldable insert 170 for assembled three-dimensional promotional literature in a partially open position attached to outer promotional literature component 175.

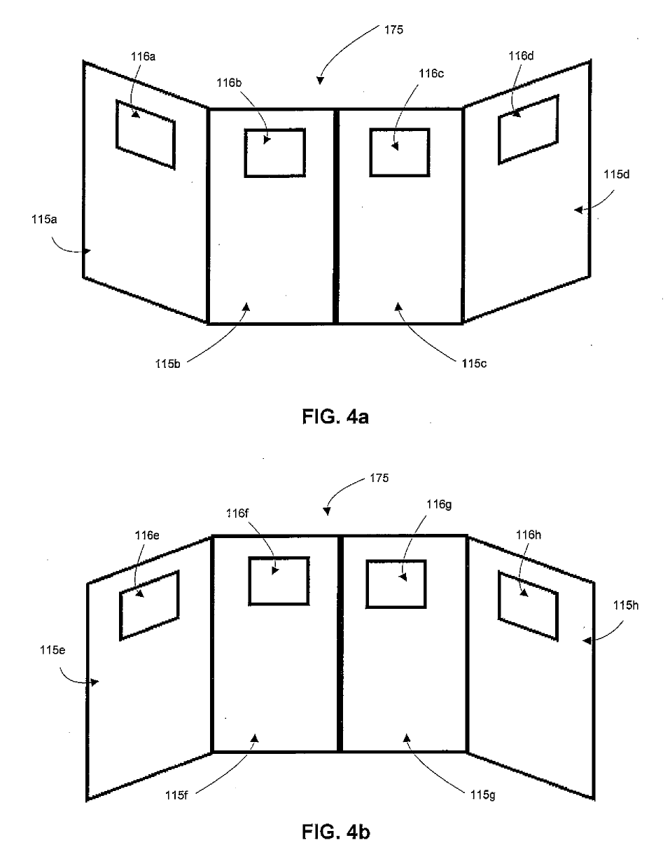

FIG. 4 shows a front view (4a) and back view (4b) of one embodiment of outer promotional literature component 170 having eight VPS surfaces outer left front VPS 115a, inner left front VPS 115b, outer right front VPS 115c, outer right front VPS 115d, outer left back VPS 115e, inner left back VPS 115f, outer right back VPS 115g, and outer right back VPS 115heach of which includes multiple VDE's such as outer left front VDE 116a, inner left front VDE 116b, outer right front VDE 116c, outer right front VDE 116d, outer left back VDE 116e, inner left back VDE 116f, outer right back VDE 116g, and outer right back VDE 116h which may be printed or produced with variations and in varying combinations using VDP or an equivalent technology. Outer promotional literature component 170 can have any number of VPS's and VDE's. Outer promotional literature component 170 can have “fewer or more” or any number of VPS's and VDE's, for example 4, 6 or 10 VPS's or 1, 2, 3 or 4 VDE's per VPS.

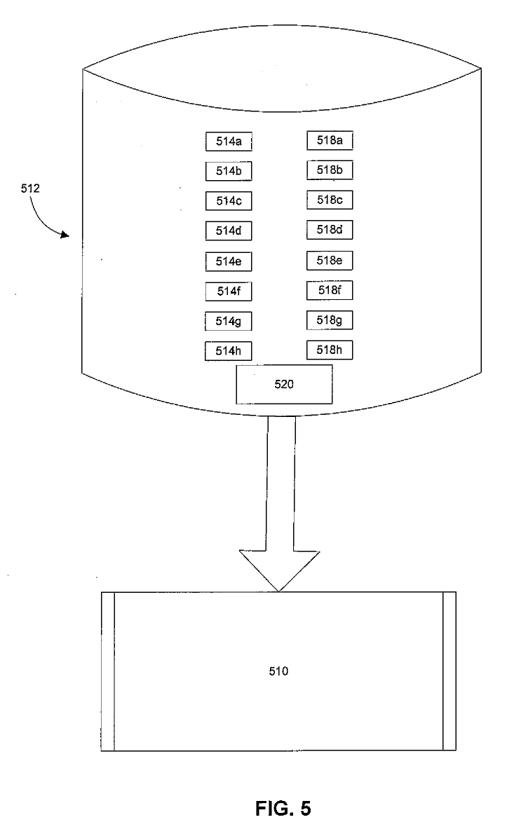

FIG. 5 shows a diagram for one embodiment of a system for creating customized, assembled three-dimensional promotional literature with VPS. The embodiment shown includes variable printing apparatus 510 which has the capability for versioning. In the embodiment shown the versioning capability of apparatus 510 allows customization of the VPS elements of the outer promotional literature component and the VDE elements within them. The embodiment shown is capable of creating an outer promotional literature component having eight VPS surfaces, each having three VDE components within them. In the embodiment shown, variable printing apparatus 510 utilizes computer medium 512 to create and track separate date files 514a-h for each VPS. In the embodiment shown, VDE elements are tracked using data files 518a-h. In the embodiment shown, all VPS and VDE files are named using a unique naming convention stored in searchable database 520 for storing and tracking each separate data file and the VPS or VDE element contained within it, and well as the VPS and VDE elements of foldable insert 170. Other embodiments may have more or fewer VPS and VDE components.

1. A method for creating customized three dimensional promotional literature comprising the steps of:
storing data to create said at least one variable printed surface including at least one variable data element in at least one data file stored in a searchable database;
selecting at least one variable printed surface from a searchable data base;
selecting at least one variable data element within said variable printed surface from a searchable database;
creating at least one customized outer promotional literature component including said at least one variable printed surface selected which includes said at least one variable data element selected;
creating at least one foldable insert including said at least one variable printed surface selected which includes said at least one variable data element selected; and
affixing or securing a selected at least one foldable insert to said at least one outer promotional literature component wherein data to create said foldable insert is stored in said searchable database

2. The method of claim 1, which further includes the step of mechanically scoring said foldable insert by a process selected from a group consisting of scoring fold lines manually, marking fold lines, calculating the position of fold-lines by numerical calculation and mechanically marking said fold lines.

3. The method of claim 1, which further includes the step of affixing said foldable insert to said outer promotional literature component by a process selected from a group consisting of applying adhesive, stapling, binding, machining or folding.

4. The method of claim 1 wherein said foldable insert is a selected from a group comprised of a biographical data, educational data, product data, statistical information, and comparative data.

5. The method of claim 1 wherein said method further includes the step of inserting an object selected from a group consisting of a magnet, a coupon, a computer data storage device, a gift card, a prepaid card and a sample product item.

6. The method of claim 1 wherein said method further includes the step of mechanically folding said foldable insert.

7. The method of claim 1 which further includes the step of tracking manual labor and coordinating labor associated with folding and assembling using a component selected from a group consisting of a scheduling method, project management software and a database.

8. The method of claim 1 which further includes the step of tracking revisions to variable printed surfaces and variable data elements using a component selected from a group consisting of a project management component selected from a group consisting of a scheduling method, project management software and a database.

9. The method of claim 8, which further includes updating a searchable data base for said revisions to said variable printed surfaces and said variable data elements.

10. A customized three-dimensional promotional literature product made by the process of:
creating at least one outer promotional literature component with at least one variable printed surface;
identifying at least one variable data element within said variable printed surface;
storing data to create said at least one variable printed surface including said at least one variable data element in at least one data file stored in a searchable database;
selecting at least one variable printed surface and at least one variable data element from said searchable data base to create a customized outer promotional literature component;
affixing or securing a selected at least one foldable insert to said at least one outer promotional literature component wherein data to create said foldable insert is stored in said searchable database

11. The product of claim 10 which further includes a layout for at least one variable printed surface capable of being retrieved from a searchable database and modified.

12. The product of claim 10 which further includes a layout for at least one variable data element capable of being retrieved from a searchable database and modified.

13. The product of claim 10 which further includes a layout for at least one foldable insert capable of being retrieved from a searchable database and modified.

14. The product of claim 10 which further includes an inserted component selected from a group consisting of a magnet, a coupon, a computer data storage device, a gift card, a prepaid card and a sample product item.

15. A system for creating customized, promotional literature which includes:
a printing apparatus capable of modifying printed surfaces and data elements and printing them;
a searchable database which includes at least one data file containing a layout for a variable printed surface for at least one outer promotional literature component and which further includes at least one data file containing a layout for a foldable insert; and
a means for affixing said at least one foldable insert to said at least one outer promotional literature component.

16. The system of claim 15 which further includes a variable printing apparatus capable of versioning.

17. The system of claim 15 which further includes at least one data file contained within a searchable database for tracking revisions to at least one variable data element within at least one variable printed surface.

18. The system of claim 15 wherein said method further includes a means for folding said foldable insert selected from a group consisting of manual folding and a mechanical folding device.

19. The system of claim 15 which further includes an interface for receiving a user-defined selection for a variable printed surface and modifying said customized promotional literature component to reflect such selection.

20. The system of claim 15 which further includes a means for affixing a foldable insert to an outer promotional literature component selected from a group consisting of mechanically applying adhesive, manually applying adhesive, manually stapling, mechanically stapling and using a paper product chemically treated to affix said foldable insert to said outer promotional literature component.
